(19) United States
(12) Patent Application Publication
(10) Pub. No.: US 2026/0163800 A1
(43) Pub. Date: Jun. 11, 2026

(54) COMMAND LINE INTERFACE TEMPLATES GENERATOR FOR NETWORK DEVICES

(71) Applicant: Cisco Technology, Inc., San Jose, CA (US)

(72) Inventors: Ryan P. Holland, Los Angeles, CA (US); Elango Ganesan, Portola Valley, CA (US); Swapna Anandan, Fremont, CA (US); Adam John Radford, Beaconsfield (AU); Aniruddh Dikhit, San Jose, CA (US)

(21) Appl. No.: 19/210,009

(22) Filed: May 16, 2025

Related U.S. Application Data
(60) Provisional application No. 63/730,719, filed on Dec. 11, 2024.

(51) Int. Cl. H04L 41/084; H04L 41/02; H04L 41/0869; H04L 41/16

(52) U.S. Cl. CPC H04L 41/084; H04L 41/024; H04L 41/0869; H04L 41/16

(57) ABSTRACT

Methods for generating multi-language command line interface templates for configuring network devices based on input queries. Methods involve obtaining an input query related to a command line interface (CLI) template for configuring one or more network devices in a network and determining contextual information about the network based on the input query. The contextual information includes a templating language. The methods further involve generating one or more CLI templates in the templating language based on the input query and the contextual information using a knowledge graph that structurally and semantically connects a plurality of CLI template snippets, and providing the one or more CLI templates for configuring the one or more network devices.

### CROSS-REFERENCE TO RELATED APPLICATION

This application claims the benefit of priority under 35 U.S.C. § 119(e) to U.S. Provisional Application No. 63/730,719 , filed on Dec. 11, 2024, which is hereby incorporated by reference in its entirety.

### TECHNICAL FIELD

The present disclosure relates to computer networking and data communications.

### BACKGROUND

Enterprises with a large networking infrastructure rely on some form of templating software to specify, distribute, and deploy configurations to their suite of network devices. Commonly, these templates involve command line interface (CLI) commands and template language syntax such as Jinja, Velocity, FreeMarker, etc. Using a template engine with CLI commands may enable powerful, flexible, low-level configurations. Although recent momentum has driven development of model and/or intent based alternatives, CLI templates may persist for many years to come to help manage network infrastructures. It is difficult to achieve proficiency in CLI templating because of a steep learning curve. Moreover, CLI templating is burdensome even for experienced users because of repetitive manual entries when generating CLI templates.

### BRIEF DESCRIPTION OF THE DRAWINGS

FIG. 1 is a block diagram of a system for generating a multi-language network device command line interface (CLI) templates for configuring network devices, according to an example embodiment.

FIG. 2 illustrates a user interface for generating CLI-based templates in a determined templating language in response to an input query, according to an example embodiment.

FIG. 3 illustrates a user interface for generating and validating CLI-based templates based on input queries, according to an example embodiment.

FIG. 4 is a diagram depicting components of a multi-language CLI-based template generator that generates CLI templates in various templating languages, according to an example embodiment.

FIG. 5 is a diagram illustrating a method of generating a knowledge graph that includes a plurality of CLI template snippets, according to an example embodiment.

FIG. 6 illustrates a portion of a knowledge graph that connects a plurality of CLI template snippets with structural and/or semantic edges, according to an example embodiment.

FIG. 7 illustrates a user interface that provides a generated CLI template snippet with a natural language description for configuring one or more network devices, according to an example embodiment.

FIG. 8 is a diagram illustrating a method of generating one or more CLI templates in a determined templating language based on an input query, according to an example embodiment.

FIG. 9 is a flowchart illustrating a method in which CLI-based language specific templates are generated based on input queries and provided for configuring network devices in a network, according to an example embodiment.

FIG. 10 is a hardware block diagram of a computing device that may perform functions associated with any combination of operations in connection with the techniques depicted and described in FIGS. 1-9, according to various example embodiments.

### DESCRIPTION OF EXAMPLE EMBODIMENTS

### Overview

Briefly, techniques are presented herein for generating multi-language command line interface templates for configuring network devices based on input queries.

In one form, methods involve obtaining an input query related to a command line interface (CLI) template for configuring one or more network devices in a network and determining contextual information about the network based on the input query. The contextual information includes a templating language. The methods further involve generating one or more CLI templates in the templating language based on the input query and the contextual information using a knowledge graph that structurally and semantically connects a plurality of CLI template snippets. The methods further involve providing the one or more CLI templates for configuring the one or more network devices.

### Example Embodiments

Currently, utility of templating integrated development environments (IDEs) that combine CLI commands and template language syntax is limited to a select cohort of expert users, proficient in both the requisite CLI and at least one of the offered templating languages. This presents a steep learning curve and high barrier for entry. In short, achieving reasonable proficiency with CLI templating is burdensome and time consuming.

Pursuing independent learning of CLI and template languages is a lengthy process, and possibly overly exhaustive, covering nuances non-applicable to core use cases. Conversely, ad-hoc searching for external references in real time mid-development is tedious, repetitive, and potentially misleading without any underlying familiarity to help distinguish between accurate or inaccurate resources. Even experts who consistently use CLI template tool(s) may encounter difficulties. With no shortcuts or intelligence embedded in the CLI templating tool(s), users are often burdened by repetitive manual entries. This not only increases time and efforts, but also amplifies the risk of unintentional human error. Additionally, experts may write CLI commands in a specific format with which they are familiar, rather than adhering to templating standards, compliance rules, or best practices. Given the ubiquity of CLI template editors in modern networking, along with the increased role of Operational Technology (OT) technicians in Information Technology (IT) use cases, this lack of usability guidance for novices, and lack of streamlined support for experts, presents an overt opportunity for improvement.

As such, considering the widespread proliferation of Artificial Intelligence (AI) augmented assistance in other editor environments, CLI template designer platforms would benefit from a similar assistance, specifically curated to meet constraints and circumstances of CLI templating. Unlike other editor environments, however, CLI template designer platforms present unique challenges of requiring precise command syntax without visual feedback or undo options. While it is easy to make a mistake, the consequences may be dire. An improper configuration of network device(s) may result in network device(s) crashing, going offline, and/or exhibiting other unexpected behaviors.

The techniques presented herein provide a multi-language CLI template engine or generator configured to streamline template design by empowering developers to auto-generate interwork operating system (IOS) CLI commands in response to natural language prompts. The techniques presented herein deploy artificial intelligence (AI) to aid in generating precise CLI templates in various templating or wrapper languages depending on user's context. For example, the CLI template content generation is powered by large language model(s) (LLMs), embedded documentation, pre-synthesized knowledge graph(s), and automatic consideration of users' specific templating environment context. In contrast to traditional chat based interfaces, the CLI templating engine is more powerful and interactive, allowing users to iteratively issue manual edits and/or request LLM-driven enhancements. The multi-language CLI template engine continuously learns, in real time, from generated CLI templates and revises the generated templating based on simulations and/or actual use.

Code developer platforms that may be powered by AI, use a fill-in-the-middle paradigm to generate suggested code. This approach is intuitive for generic language-agnostic code, as the range of possible input is substantially open-ended. However, the set of CLI queries, especially asked within the context of writing templates, is more limited. Thus, CLI prompts can be reliably anticipated prior to run time, tagged with pre-computed metadata, and statically deployed in a manner that streamlines response times and rigidly ensures accuracy for common queries.

The techniques presented herein accurately configure different network devices in a network based on generated CLI templates in determined templating languages. As such, it is convenient for inexperienced users that may lack knowledge of the templating language, CLI commands, and/or networking environment (network devices). The multi-language CLI-based template generator may generate CLI templates without repetitive manual entries and without costly human errors.

The techniques presented herein involve obtaining an input query related to a command line interface (CLI) template for configuring one or more network devices in a network and determining contextual information about the network based on the input query. The contextual information includes a templating language. The techniques presented herein may further involve generating one or more CLI templates in the templating language based on the input query and the contextual information using a knowledge graph that structurally and semantically connects a plurality of CLI template snippets. The techniques presented herein provide, and may execute, the one or more CLI templates for configuring the one or more network devices.

While in example embodiments described below, Large Language Models (LLMs) are deployed, these are just non-limiting examples of AI/ML models. In another example embodiment, other AI/ML models may be deployed such as unsupervised machine learning, supervised machine learning, deep neural networks, generative adversarial network, other language models such as recurrent neural networks, generative pre-trained transformers (GPT), bidirectional encoder representations from transformers (BERT), text-to-text transfer transformers (T5), etc.

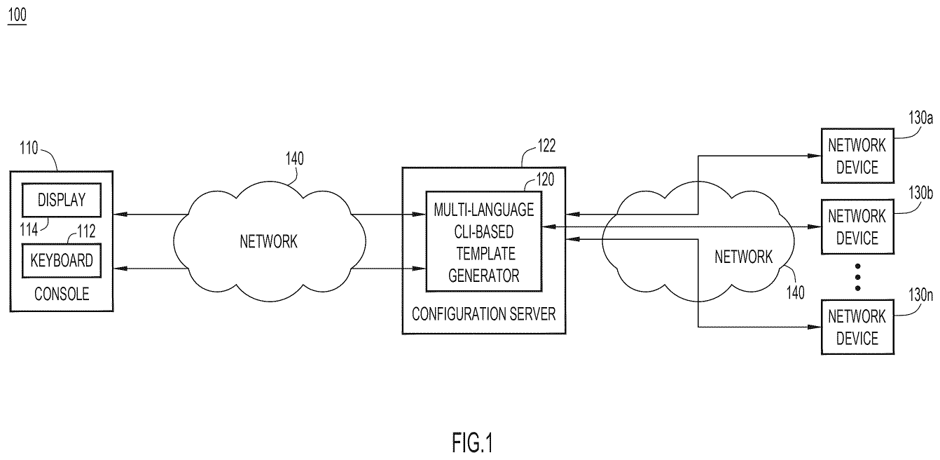

Turning now to FIG. 1, FIG. 1 is a block diagram of a system 100 for generating a multi-language network device CLI templates for configuring network devices, according to an example embodiment. The system 100 includes a number of entities and one or more networks 140. The entities include a console 110, a multi-language CLI-based template generator 120 running on one or more server(s), such as a configuration server 122, and network devices 130a-n.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

The entities (servers, network devices, computing devices, endpoints, etc.) of the system 100 communicate via the one or more networks 140. The one or more networks 140 may include a local area network (LAN), a wide area network (WAN) such as the Internet, or a combination thereof, and includes wired, wireless, or fiber optic connections. In general, the one or more networks 140 can use any combination of connections and protocols that support communications between the entities of the system 100.

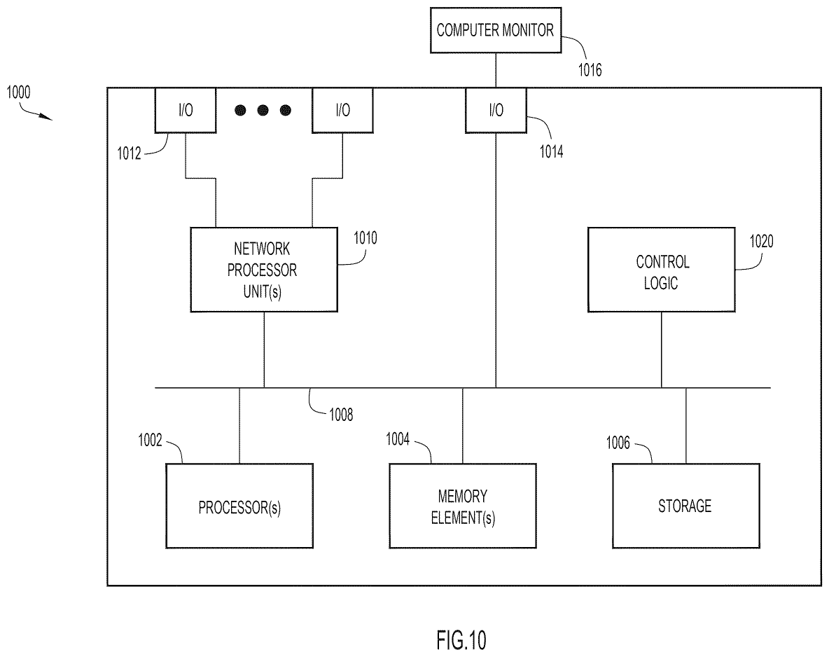

In various example embodiments, the entities of the system 100 (the console 110, the configuration server 122, and the network devices 130a-n) may each include a network interface, at least one processor, and a memory. Each entity may be any programmable electronic device capable of executing computer readable program instructions. The network interface may include one or more network interface cards that enable components of the entity to send and receive data over the one or more networks 140. Each entity may include internal and external hardware components such as those depicted and described in further detail in FIG. 10.

The console 110 is a computer device, an endpoint apparatus, or a client device. The console 110 includes a user interface (e.g., a keyboard 112) configured to obtain input from an operator and configured to provide output to the operator (e.g., via a display 114). The console 110 communicates with and configures one or more of the network devices 130a-n, via the configuration server 122, using a secure shell (SSH) connection, for example. User may input natural language (NL) prompt(s) and/or other input queries requesting data and/or action(s) from the network devices 130a-n and obtain, from the configuration server 122 and/or the multi-language CLI-based template generator 120, a set of CLI commands (a CLI template) in a proper template format and in a templating language of the user's environment. In one example embodiment, the configuration server 122 (that includes the multi-language CLI-based template generator 120) may generate CLI templates in proper template format(s) and in the determined templating language, and then execute these CLI templates on one or more of the network devices 130a-n. The results of these configuration actions may then be reported to the user via the console 110. That is, the configuration server 122 may be a controller that configures and manages the network devices 130a-n.

In one or more example embodiments, the multi-language CLI-based template generator 120 may enable a user, such as a network operator, to generate CLI commands in particular templating language(s) based on natural language user prompts (input queries). The CLI commands may be executed on the network devices 130a-n, by the configuration server 122, to perform maintenance, change configurations, gather telemetry data, or troubleshoot a connectivity problem, network latency issues, security issues, or other network problems. As a consequence of executing the CLI templates, network asset(s) may be reconfigured to use a different port, change links (connect to a different network device), enable monitoring of incoming or outgoing packets, etc.

According to one or more example embodiments, the console 110 and the multi-language CLI-based template generator 120 may be integrated into a single computing device or an apparatus such as the configuration server 122 or a network controller.

In the system 100, the multi-language CLI-based template generator 120 is executing on the configuration server 122. This is just an example and the disclosure is not limited thereto. The multi-language CLI-based template generator 120 may be executing on a separate apparatus such as computing server(s) or in a cloud.

The multi-language CLI-based template generator 120 includes one or more modules or units to perform various functions of example embodiments in this disclosure. The multi-language CLI-based template generator 120 may be implemented by any combination of any quantity of software (and/or hardware modules or units), and may reside fully or partially within a memory of the configuration server 122 for execution by a processor. The multi-language CLI-based template generator 120 may include or involve one or more AI model(s) such as an LLM that is trained to generate CLI templates in detected or determined templating language(s) based on NL prompts (input queries).

In one or more example embodiments, the system 100 is a full-stack system that supports automated generation of network device CLI templates, which may be encapsulated and rendered as a CoPilot like user experience. The multi-language CLI-based template generator 120 may aid novice users in rapidly learning the syntax, semantics, and constructs for both CLI and templating languages (i.e., Jinja, Django, Velocity, etc.). Additionally, the multi-language CLI-based template generator 120 may also benefit expert users, streamlining development process by enhancing recalls, minimizing risk of human errors, and adhering to templating “best practices”.

From a user-facing perspective, the user provides a natural language (NL) input query or prompt related to a CLI template for configuring network devices in a network. Then, the user receives, from the multi-language CLI-based template generator 120, a curated assortment of relevant data, automatically generated, formatted, and validated by the multi-language CLI-based template generator 120. This generated data may include one or more of the following:
(1) One or more recommendations for CLI command sets or CLI templates (in a proper template format and templating language).
(2) Details for variables in the CLI templates. These details may include types of variables or parameters, their descriptions or explanations for these parameters, default values, allowable ranges, etc.
(3) Suggested alternate prompts (innately guides the user to more precise questioning).
(4) Relevant documentation excerpts (allows user to reference ground truth sources).

The suggested alternate prompts or queries and the relevant documentation excerpts are examples of knowledge-graph insights obtained leveraging pre-synthesized data (generated metadata) from embedded examples. The user may then accept (apply) the output, discard the output, manually edit the output, or iteratively request additional LLM-driven enhancements to the output (i.e., change input query based on the suggested alternate prompts, replace variables with static values, optimize with loop constructs, etc.). In one example embodiment, the generated CLI templates may be executed by the configuration server 122 on the network devices 130a-n without any user involvement.

As an example, the configuration server 122 may execute a first CLI template, which is formatted in Jinja language by the multi-language CLI-based template generator 120, on a first network device 130a to reconfigure network settings such as changing an active port, assigning different network addresses, etc. The configuration server 122 may execute a second CLI template and a third CLI template, which are formatted in the Velocity language by the multi-language CLI-based template generator 120, on a second network device 130b and on a third network device 130n, respectively, setting an authentication and access control or setting a Remote Authentication Dial-In User Service (RADIUS).

The network devices 130a-n may include line cards or stand-alone instances of one or more of switches, routers, hubs, gateways, repeaters, access points, traffic classifiers, firewalls, intrusion detectors, and the like. That is, the network devices 130a-n are electronic or computing devices used in networking such as networking equipment, a network node, a network management device, a network controller, and so on. These network devices 130a-n are typically used (a) to transmit and receive data between various endpoint devices and/or (b) to control and configure the transmission of data among various devices in the network such as a network controller, a network management device, and the like.

While only one configuration server is depicted in FIG. 1, the number of the configuration servers may depend on a particular configuration of the system 100. For example, there may be multiple configuration servers or network controllers, each connected to a respective set of the network devices 130a-n. In one example embodiment, a respective network controller with connected network devices 130a-n may form a client network, which then connects to the console 110. In another example embodiment, the console 110 may connect to various configuration servers to interface with various enterprise networks. Each enterprise network has its own environment. Techniques presented herein allow the console 110 to interact with devices of various enterprise networks using the CLI templates generated by multi-language CLI-based template generator 120, which are then deployed to obtains data from the network devices 130a-n (e.g., gather telemetry data) and/or control/configure the network devices 130a-n.

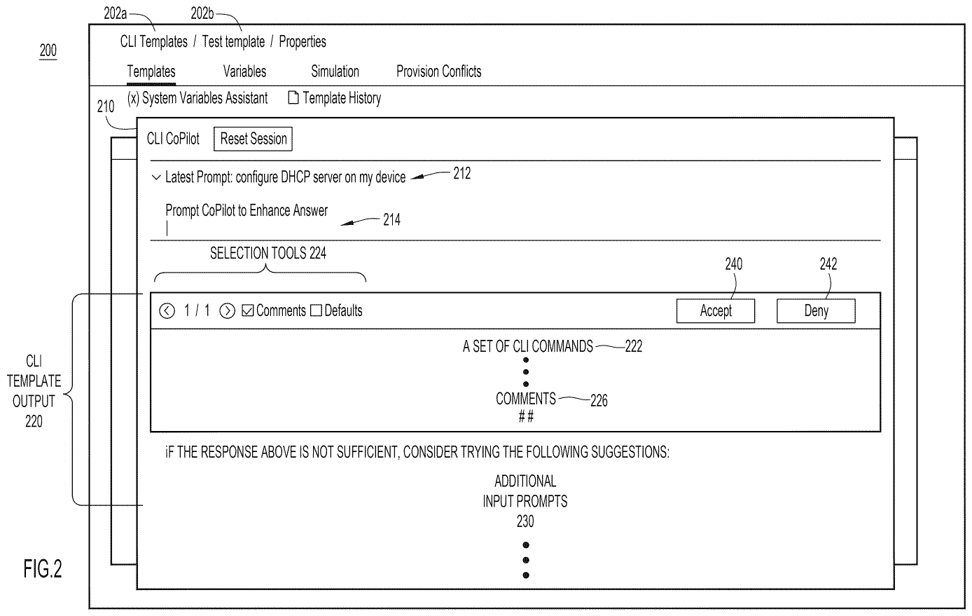

With continued reference to FIG. 1, FIG. 2 illustrates a user interface 200 for generating and validating CLI-based templates in a determined templating language in response to an input query, according to an example embodiment. The user interface 200 includes features 202a-b and a CLI CoPilot 210 having input queriers (a NL prompt 212 and/or an input line 214) and CLI templates such as a CLI template output 220 with one or more CLI templates (a set of CLI commands 222, selection tools 224, and comments 226) and additional input prompts 230. The user interface 200 further includes options to execute a CLI template via an accept icon 240 and to discard the CLI template via the deny icon 242.

Specifically, the features 202a-b includes a first feature (a CLI templates feature 202a) for enabling CLI template generations and a second feature (a test template feature 202b) for enabling validation of the generated CLI templates by performing a simulation or by executing a respective CLI template on an emulated network device. Based on enabling the CLI templates feature 202a, the CLI CoPilot 210 (e.g., a structured UI window) is provided.

The CLI CoPilot 210 is configured to obtain input queries and generate and provide CLI templates. For example, the input query is the NL prompt 212 such as “configure [Dynamic Host Configuration Protocol] DHCP server on my device”. The NL prompt 212 may include another input line 214 “prompt CoPilot to enhance answer”, where the user may input additional NL queries such as additional network devices to configure or DHCP parameters (address ranges), etc. The multi-language CLI-based template generator 120 of FIG. 1 outputs CLI templates in determined templating language(s) based on the input query (the NL prompt 212 and/or the input line 214). As an example, the multi-language CLI-based template generator 120 may generate the CLI template output 220, which includes a set of CLI commands 222 and optionally comments 226. For example, the set of CLI commands 222 may include:
ip dhcp excluded-address {{excluded_start}} {{excluded_end}}
ip dhcp pool {{pool_name}}
network {{network}} {{subnet_mask}}
default-router {{default_router}}
dns_server {{dns_server}}
lease {{lease_time}}

In one example embodiment, users may select templating language(s) for the set of CLI commands 222 via the selection tools 224. However, the templating language(s) are automatically determined by the multi-language CLI-based template generator 120 based on contextual information (e.g., user's CLI editor environment). As such, the set of CLI commands 222 are in the selected templating language and include variables specific to the network/network assets. Variables include parameter types, descriptions, names, ranges, values, etc. By manipulating the selection tools 224, users may select to include natural language descriptions (comments 226) for the set of CLI commands 222, default values, etc. For example, the comments 226 for the set of CLI commands 222 may be:
{#exclude addresses from the DHCP pool #}
{#Create a DHCP pool #}
{#Specify the network and subnet mask for the DHCP pool #}
{#Set the default router for the DHCP clients #}
{#Set the DNS server for the DHCP clients #}
{#Set the least time for the DHCP addresses #}.

The additional input prompts 230 are suggestions for generating one or more related sets of CLI commands. For example, the additional input prompts 230 may be: “How do I configure a DHCP pool on my device?”, “What commands are needed to set the DHCP address range?”, “How can I configure DHCP options for my DHCP server?”, “What is the command to enable DHCP on a specific interface?”, etc.

In one or more example embodiments, the user interface 200 may include one or more links to relevant documentation excerpts (ground truth sources) and options to accept the generated CLI template (the accept icon 240), in which case the CLI template is populated with parameter values based on contextual information (the network and network device(s) details) and is executed for configuring the one or more network devices. The user may select to discard the generated CLI template by selecting the deny icon 242.

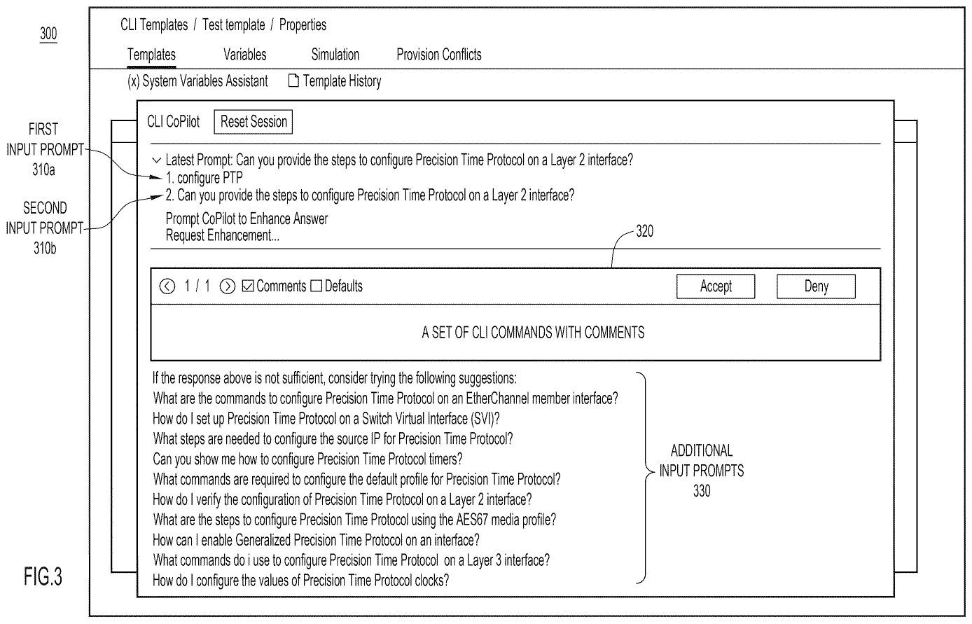

With continued reference to FIGS. 1 and 2, FIG. 3 illustrates a user interface 300 for generating and validating CLI-based templates based on input queries, according to an example embodiment. The user interface 300 includes a first input prompt 310a, a second input prompt 310b, and CLI template output 320 with additional input prompts 330.

For example, the first input prompt 310a may be “configure [Precision Time Protocol] PTP” and the second input prompt 310b (subsequent prompt, enhancement), which may be selected from additional input prompts 330, may be “Can you provide steps to configure PTP on a Layer 2 interface?”. Users may further enhance NL query by requesting enhancements “prompt CoPilot to enhance answer”.

The multi-language CLI-based template generator 120 generates the CLI template output 320 which includes a set of CLI commands in a selected or determined templating language with natural language descriptions (“comments”). In a given example, the CLI template output 320 may include:
{#specifies the physical interface to be configured. #}
interface {{Interface_id}}
{#Enables Precision Time Protocol on the interface. #}
ptp enable
{#sets the PTP VLAN on a trunk port. #}
Ptp vlan {{ptp_vlan}}
{#Enables the interface. #}
no shutdown.

The set of CLI commands are in the selected templating language and includes variables specific to network devices of a network. Variables include types, descriptions, names, ranges, values, etc. such as port numbers and interface addresses. The additional input prompts 330 are generated based on the second input prompt 310b to retrieve related CLI templates. By using multiple prompts (enhancements), a precise set of CLI commands may be generated. The generated set of CLI commands may be tested on a target emulated network device to ensure correctness.

With continued reference to FIGS. 1-3, FIG. 4 is a diagram depicting components 400 of the multi-language CLI-based template generator 120 of FIG. 1 that generates CLI templates in various templating languages, according to an example embodiment. The components 400 include an external service 410 having an LLM component 412 and a CLI template generator 420. The CLI template generator 420 includes datastores 421 having vector databases 422a-b and a back-end control logic component 424. The components 400 further include a plurality of external rule resources 430, an expert user contributions 432, a snippet extractor 434 for extracting CLI template snippets from a plurality of template sources 436a-c, a template editor 440 which includes a templated editor back end component 442 and a template editor UI component 444 that interfaces with a user such as a template designer 450.

The components 400 are just one non-limiting example of the multi-language CLI-based template generator 120. The multi-language CLI-based template generator 120 may granularly comprise various functional blocks such as one or more vector databases, an internal or an external LLM, a back-end controller logic, an application programming interface (API) infrastructure, and one or more user interface components. These blocks and inter-block interactions are carefully designed and sequenced to generate CLI-based templates. Some of the components 400 may be split into further blocks depending on a particular design and use case scenario.

The external service 410 includes one or more AI models (the LLM component 412). In one example embodiment, the external service 410 may be an internal service. In yet another example embodiment, the external service 410 may include an internal AI model and an external AI model, which depends on a particular deployment and use case scenario. Further, the LLM component 412 may include multiple LLMs such as a first LLM for generating a template rule book vector database 422a and a second LLM for generating a template snippets vector database 422b.

The LLM component 412 is configured to generate a template rule knowledge graph and a CLI snippet knowledge graph. Each node in a generated knowledge graph is tagged with context-aware metadata and optionally intent. As an example, the context-aware metadata for a node in the CLI snippet knowledge graph includes one or more network device types, one or more parameters, and acceptable values for the one or more parameters for CLI commands in a respective CLI template snippet. The intent includes a plurality of natural language prompts related to the respective CLI template snippet.

The LLM component 412 is involved in generating template rules and connecting them semantic and structurally to other template rules in the template rule book vector database 422a and is involved in generating the CLI template snippets and connecting them structurally and semantically to other CLI template snippets in the template snippets vector database 422b (before runtime-offline and during runtime-online). The LLM component 412 is further involved in generating the one or more CLI templates based on input queries during runtime.

In one example embodiment, the LLM component 412 may include separate ML/AI models for each vector database for better precision and accuracy. Additionally, the LLM component 412 may include separate ML/AI models for offline and online processing. As an example, a large AI model may generate the vector databases 420a-b before runtime and a smaller AI model may generate CLI templates at runtime, which improves efficiency and decreases computational resources.

The CLI template generator 420 includes the template rule book vector database 422a for template rules, a template snippets vector database 422b for CLI template snippets, and back-end control logic component 424 which includes prompt engineering component for interfacing with the LLM component 412 and Application Programming Interface (API) logic for interfacing with the template editor 440.

The CLI template generator 420 obtains various rules related to formatting the templates, best practices, enterprise constraints, etc., from a plurality of external rule resources 430. The plurality of external rule resources 430 may include enterprise databases, web documents, use manuals, and even user specific or expert preferences. Additionally, expert user contributions 432 may modify one or more of the template rules or may delete or add new template rules.

The CLI template generator 420 further obtains a plurality of CLI template snippets, which are generated by the snippet extractor 434. The snippet extractor 434 parses a plurality of template sources 436a-c to extract CLI template snippets. The plurality of external sources 436a-c may include existing templates 436a, user guides 436b, and/or external resources 436c (examples available online).

The template editor 440 includes the templated editor back end component 442 and the template editor UI component 444. The template editor UI component 444 interfaces with the template designer 450 (user) and obtains input queries from the template designer 450. The templated editor back end component 442 may determine contextual information about the network based on the input query and other information such as internal configurations. For example, the templated editor back end component 442 may determine current templating language being used by the template designer 450 and/or whether the input query includes a templating language. Based on the foregoing, the templated editor back end component 442 is configured to generate a template generation request to the CLI template generator 420 providing the input query and contextual information about the network.

Specifically, before runtime, the components 400 may perform the following operations. At 460, the CLI template generator 420 obtains templating rules from the plurality of external rule resources 430 and prompts the LLM component 412 to generate nodes (structurally and semantically connected) for the rule based knowledge graph. The LLM component 412 generates the nodes and provides them the CLI template generator 420, which are then stored in the template rule book vector database 422a.

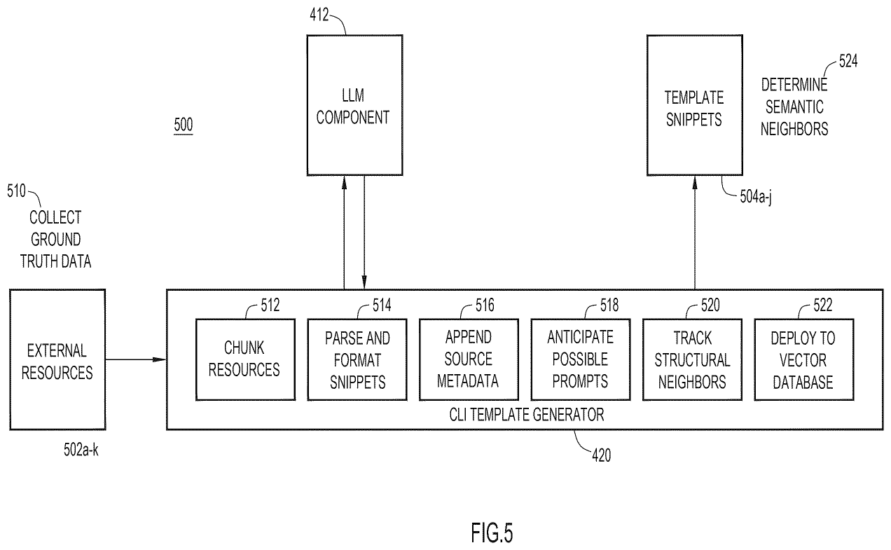

Additionally, at 466, the snippet extractor 434 extracts CLI template snippets from the plurality of template sources 436 a-c and at 462, the snippet extractor 434 queries the LLM component 412 to generate CLI template snippet nodes (structurally and semantically connected) for the template knowledge graph. The snippet extractor 434 may also leverage the LLM component 412 to aid in the chunking process, splitting the input documents intelligently e.g., by section. At 464, the snippet extractor 434 obtains the CLI template snippet nodes from the LLM component 412 and at 468, the snippet extractor 434 stores the CLI template snippet nodes in the template snippets vector database 422b. That is, the CLI template snippet nodes are deployed in the template snippets vector database 422b for runtime usage, as detailed in FIG. 5.

At 470, the expert user contributions 432 may be applied to modify the nodes stored in the template rule book vector database 422 a and at 472, the expert user contributions 432 may be applied to modify the nodes stored in the template snippets vector database 422b.

During runtime, the components 400 may perform the following operations. At 480, the template designer 450 submits a natural language input query (NL prompt). The template editor 440 gather contextual information such as whether the NL prompt includes a templating language, the templating language in the template editor 440, details about the network devices in the network, etc. At 482, the template editor 440 calls a template generation API (provides the input query and contextual information) to the back-end control logic component 424 of the CLI template generator 420. Based in the input query and contextual information, the back-end control logic component 424 queries the vector databases 422 a-b, at 484. At 486, obtains one or more relevant CLI template snippets and rules to apply. Operations 484 and 486 provide an example of retrieval augmented generation (RAG) retrieval.

The back-end control logic component 424 is configured to generate an LLM prompt that includes the input query, determined contextual information including the templating language and the retrieved CLI template snippets, and rules. At 488, the back-end control logic component 424 issues an LLM call to the LLM component 412 to generate one or more CLI templates in the determined templating language.

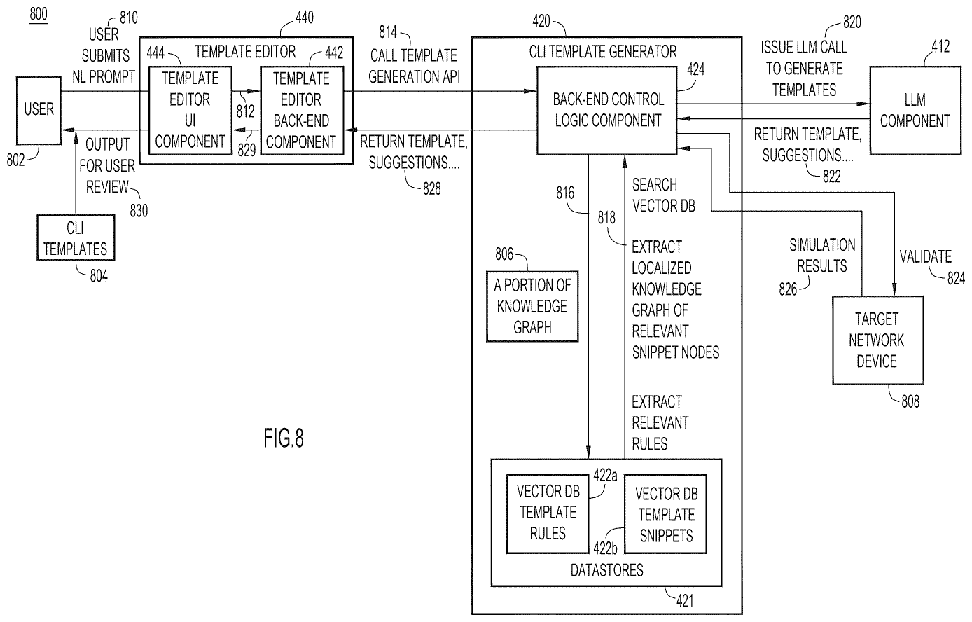

At 490, the LLM component 412 generates one or more CLI templates along with variables, descriptions and/or suggestions of additional input prompts to the back-end control logic component 424, which at 492 provides the CLI template output to the template editor 440. At 494, the template editor 440 may then provide the CLI template output to the template designer 450, an example of which is described in FIG. 8. In one example embodiment, the back-end control logic component 424 may configure one or more network devices using the generated CLI templates without user involvement e.g., via a configuration server.

With continued reference to FIGS. 1-4, FIG. 5 is a diagram illustrating a method 500 of generating a knowledge graph that includes a plurality of CLI template snippets, according to an example embodiment. The method 500 of generating a knowledge graph is performed by the multi-language CLI-based template generator 120 of FIG. 1 running on one or more computing devices of FIG. 10, for example.

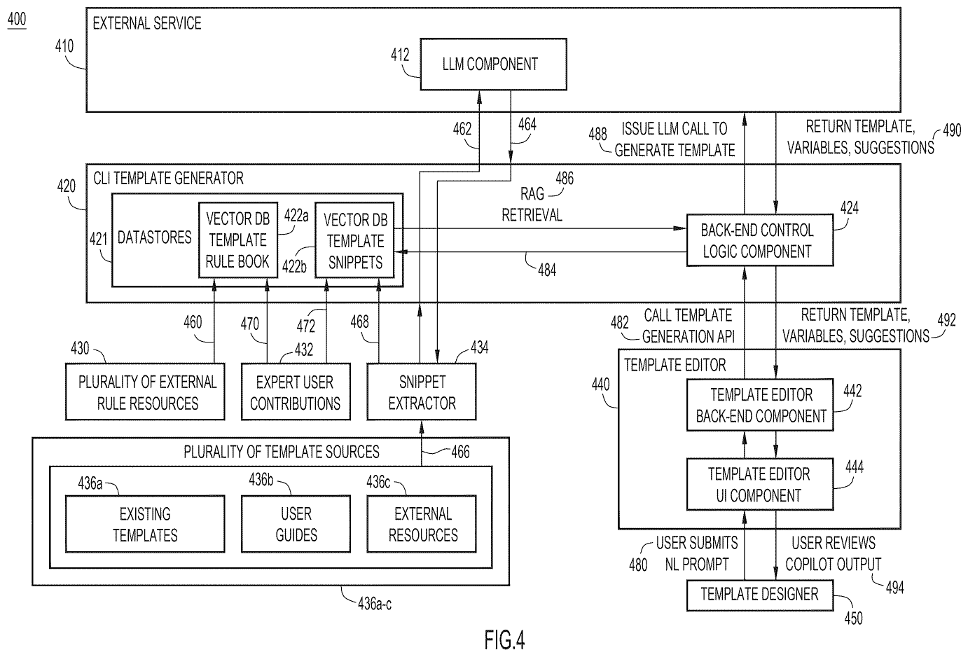

The method 500 involves the CLI template generator 420 obtaining sets of CLI commands and/or CLI rules from a plurality of external resource 502a-k such as the plurality of external rule resources 430 and/or the plurality of template sources 436a-c of FIG. 4 and prompting the LLM component 412 of FIG. 4 to generate templating rules for the template rule book vector database 422a and/or the template snippets 504a-g the template snippets vector database 422b.

The method 500 is performed prior to runtime, referred to as a “knowledge graph generation phase”. Also, the method 500 may be continuously executed during runtime, referred to as a “reference phase”. During runtime, the method 500 is performed based on generated CLI templates or newly added resources. In one or more example embodiments, generated knowledge graph(s) are continuously updated based on newly added resources and/or generate CLI templates/templating rules.

While the method 500 illustrates generating a knowledge graph for a plurality of CLI template snippets, this is just an example. The method 500 may be performed for generating a knowledge graph for templating rules. The templating rules may include formatting type rules such as setting default modes for network devices (global vs local mode), setting trim lines to avoid empty spaces, avoiding abbreviations of CLI commands. The templating rules may further include avoidance rules such as avoid setting values (#set) for parameters or constructs (because they are set elsewhere), and avoid end commands. The templating rules may further include edge case rules such as for general prompts provide a longer or broader CLI template to cover additional commands. These are just some non-limiting examples of the templating rules and the disclosure is not limited thereto.

In short, while the notion of knowledge graphs primarily applies to template snippets, knowledge graphs can also be generated for template rules. Rules may specify specific formatting guidelines, content to avoid, edge case behavior, or organizational compliance standards. At scale, these template rules may also be tagged with intents, semantically analyzed to form edges, deployed in a vector database as a knowledge graph, and referenced during run time.

The method 500 performed in the knowledge graph generation phase is a unique technique from typical vector database generations. As opposed to core prompting an LLM at run time, the multi-language CLI-based template generator 120 leverages embedded knowledge graphs extracted from ground truth resources. This knowledge is ingrained within either unstructured files (e.g., portable document format (PDF) files) or inconsistently structured files (e.g., template definitions). Despite these challenges, the multi-language CLI-based template generator 120 uses the method 500 for parsing, extracting, and structuring knowledge in a consistent, unified format of CLI template snippets.

Beyond just the CLI snippet content itself, CLI template snippets include context-aware or contextual metadata such as source tracking, as well as relevant filters to determine context-dependent applicability (i.e., device series, device types, versions, licensing), intent, and structural and semantic connections with other CLI snippets.

Specifically, the method 500 involves at 510, collecting ground truth data from the external resources 502a-k. Unlike conventional techniques that collect and store source data in vector databases, the generated CLI snippets 504a-g from the ground truth data are validated to ensure accuracy. For example, the one or more CLI snippets 504a-g may be executed on a target network device in a simulated network and a simulation result is generated indicative of whether the target network device is configured properly. As such, the one or more CLI snippets 504a-g are validated (or partially validated only for some network device types) based on the simulation result. The generated CLI snippets 504a-g (that are also validated) are then stored in a knowledge graph.

The method 500 further involves at 512, chunking or splitting sets of CLI commands into CLI template snippets. That is, the CLI template generator 420 obtains data related to some CLI or templating language (documentation excerpts) from external sources 502a-k such as documentation excerpts and chunks the unstructured data or file into structured sections. The CLI template generator 420 identifies pertinent examples relevant to CLI templating, and then reformats examples into CLI template snippets.

Additionally, at 512, the CLI template generator 420 obtains pre-existing CLI templates and also chunks them into CLI template snippets. Given any CLI template definition, regardless of format (e.g., JavaScript Object Notation (JSON), Extensible Markup Language (XML), text file document (txt)), the CLI template generator 420 chunks the full CLI template into logically grouped lines and then reformats those groups into CLI template snippets i.e., a set of CLI commands that perform a particular configuration action (set up a network port).

Moreover, at 512, the CLI template generator 420 may obtain manually added CLI template snippets e.g., via the expert user contributions 432 of FIG. 4. In addition to the automated extraction processes performed by the CLI template generator 420, the multi-language CLI-based template generator 120 also allows for manually defined CLI template snippets, either stored globally for universal reference, or scoped for local, enterprise-specific use.

In one example embodiment, the multi-language CLI-based template generator 120 may extract structures, and embed knowledge through two pipelines, by way of an example: (1) document excerpts and (2) static question answer pairs.

For relevant resources, the multi-language CLI-based template generator 120 parses unstructured files such as PDFs into sections and reformats each into a consistent, well-defined documentation chunk. A chunk may include raw text content, segment titles, chapter titles, document titles, device types, IOS firmware versions, generated summaries, and CLI command examples. These helpful chunks of documentation may be stored in a vector database for an eventual runtime retrieval.

For all relevant resources, the multi-language CLI-based template generator 120 generates a list of questions a user may potentially ask that may be answered with the extracted text and/or examples. These direct question answer pairs are also stored for eventual runtime retrieval. In one example embodiment, in addition to documentation, static pre-compiled answers may be sourced from CLI experts or manually added in response to observed behavior. Typically, static pre-computed answers should address frequently asked queries.

The method 500 further involves at 514, the CLI template generator 420 parsing and formatting the chunked resources i.e., the CLI template snippets using the LLM component 412. The chunked or extracted data is provided to the LLM component 412, which generates a CLI template snippet in a structured uniform format. At 516, the CLI template generator 420 appends context-aware metadata as well as source metadata (links to a source of ground truth) to each generated CLI template snippet.

Beyond the snippet content and context-aware metadata, the method 500 further involves at 518, each CLI template snippet being tagged with a variety of intents (question and answer pairs). Intents are pre-anticipated prompts or input queries that users might ask the multi-language CLI-based template generator 120. As an example, a snippet X is tagged with intent Y conveying that if asked a prompt similar to intent Y, the multi-language CLI-based template generator 120 would benefit from referencing the snippet X.

In one or more example embodiments, given that multi-language CLI-based template generator 120 is specifically tailored for generating CLI templates in a determined templating language (a far narrower genre of prompts that are specifically tied to network device templating) as opposed to the vast pool of input queries that a general-purpose system such as GitHub accounts for, input queries or prompts may be reliably catalogued prior to runtime. This is accomplished via a combination of expert manual curation and the LLM assisted generation. Once tagged with intents, the CLI template snippets are ready to serve as nodes in an embedded knowledge graph. By uniquely tagging the CLI template snippets with context-aware metadata (one or more network device types, one or more parameters, and acceptable values for the one or more parameters for CLI commands) and intent (a plurality of natural language prompts related to the respective CLI template snippet), accurate CLI templates may be generated that avoid conflicts (e.g., cannot be applied to a target network device because of a device type) and other issues in configuring network devices (e.g., conflicts between network devices).

The method 500 further involves at 520, tracking, by the CLI template generator 420, structural neighbors of the CLI template snippets. Structurally connected CLI template snippets are typically from the same source of truth. For example, structurally connected CLI template snippets may be from the same online resource, from the same document, created by the same expert, etc.

The method 500 further involves at 522, deploying the CLI template snippets 504 a-g to a vector database and at 524, semantically connecting the CLI template snippets 504 a-g to other CLI template snippets in the vector database. In other words, semantic neighbors for the CLI template snippets 504a-g are determined when deploying the CLI template snippets 504a-g into the vector database. Unlike structural connections that are based on sources of truth, semantic connections are based on intents (and optionally context-aware metadata).

With continued reference to FIGS. 1-5, FIG. 6 illustrates a portion of a knowledge graph 600 that connects a plurality of CLI template snippets with structural and/or semantic edges, according to an example embodiment. A depicted portion of the knowledge graph 600 includes a plurality of nodes 610a-j that are structurally and semantically connected to one another by structural edges 612 and semantic edges 614.

By way of an example, the plurality of nodes 610a-j include a first node 610a, a second node 610b, a third node 610c, a fourth node 610d, a fifth node 610e, a sixth node 610f, a seventh node 610g, an eight node 610 h, a ninth node 610 i, and a tenth node 610 j.

The first node 610a is a CLI template snippet for configuring a Hot Standby Router Protocol (HSRP). This CLI template snippet configures HSRP on an interface with IP address and priority settings on network devices A, B, C. It is in a first templating language and has a source of “IP Addressing Services Guide” with a source type being “a user guide document”.

The second node 610b is a CLI template snippet for VLAN mapping. This CLI template snippet configures VLAN mapping on a trunk port of network devices A, B, C. It is in the first templating language and has a source of “IP Addressing Services Guide” with a source type being “a user guide document”.

The third node 610c is a CLI template snippet for a Parallel Redundancy Protocol (PRP) channel VLAN. This CLI template snippet configures PRP channel interface in trunk mode with allowed VLAN on network devices A and B. It is in the first templating language and has a source of “Layer 2 Configuration Guide” with a source type being “a user guide document”.

The fourth node 610d is a CLI template snippet for a VLAN load balancing. This CLI template snippet configures VLAN balancing on specific interfaces on network devices A, B, and D. It is in the first templating language and has a source of “Layer 2 Configuration Guide” with a source type being “a user guide document”.

The fifth node 610e is a CLI template snippet for a VLAN IP address. This CLI template snippet configures VLAN interface with an IP address and subnet mask for network devices A, B, C, and D. It is in the first templating language and has a source of “Layer 2 Configuration Guide” with a source type being “a user guide document”.

The sixth node 610f is a CLI template snippet for configuring port priority. This CLI template snippet configures port priority for a specified interface and VLAN for network devices A, B, C, and D. It is in the second templating language and has a source of “Layer 2 Configuration Guide” with a source type being “a user guide document”.

The seventh node 610g is a CLI template snippet for configuring voice VLAN. This CLI template snippet configures a voice VLAN on a specified interface for network devices C and D. It is in the second templating language and has a source of “Profinet Configuration Guide” with a source type being “a user guide document”.

The eight node 610h is a CLI template snippet for configuring an access port. This CLI template snippet configures a range of access ports for network devices A, B, C, and D. It is in the first templating language and has a source of “data center cloud prep environment” with a source type being “existing template”.

The ninth node 610i is a CLI template snippet for configuring VLAN. This CLI template snippet configures multiple VLANs with their respective names for network devices A, B, C, and D. It is in the first templating language and has a source of “data center cloud prep environment” with a source type being “existing template”.

The tenth node 610j is a CLI template snippet for configuring VLAN IP and HSRP. This CLI template snippet configures the interface for a specific VLAN identifier with IP and HSRP settings for network devices A, B, C, and D. It is in the second templating language and has a source of “data center cloud prep environment” with a source type being “existing template”.

The nodes 610a-j are structurally and semantically connected forming a portion of the knowledge graph 600. On a continuous basis, as new CLI template snippets are embedded in deployment, the CLI template generator 420 dynamically generates a secondary layer of edges connecting CLI snippet nodes. These edges are indicative of similarities between CLI template snippets, and by extension, similarity between their tagged intents. In one or more example embodiments, the knowledge graph edges fall under two categories: (1) structural edges 612 and (2) semantic edges 614.

Structural edges 612 connect two neighboring CLI template snippets according to the static structure of their source entity. For example, two CLI template snippets extracted from the same chapter of a document, or the same pre-existing template, may be connected via a structural edge. These structural edges 612 are rigid and do not change as new nodes are deployed.

Semantic edges 614 connect two neighboring CLI snippets according to semantic similarity of their intents. For example, two snippets configuring similar aspects, but pulled from two entirely different source destinations, may be connected via a semantic edge. These semantic edges 614 are fluid and may change dynamically as new nodes are deployed.

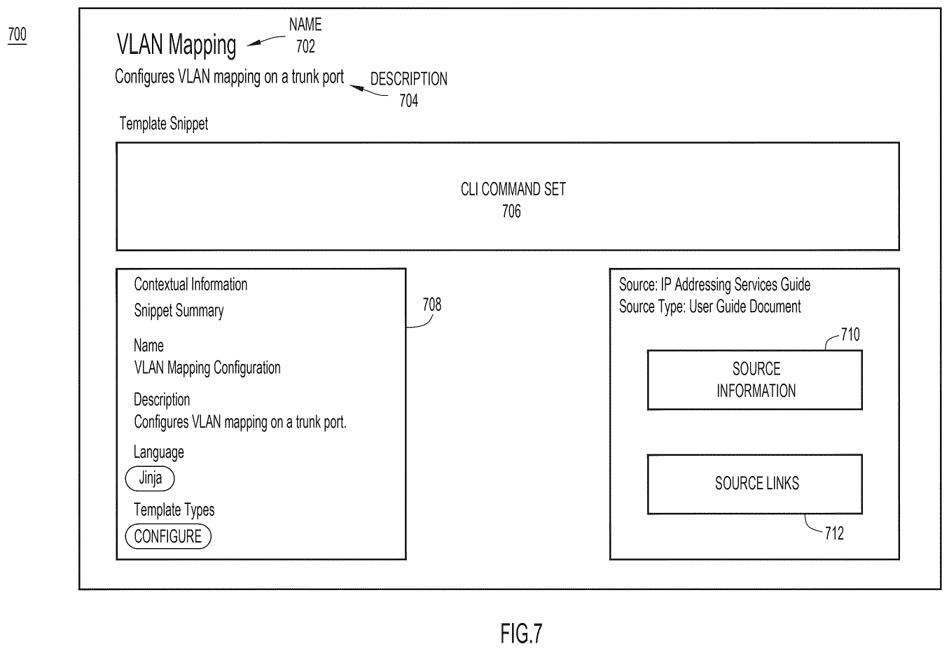

Users may view various CLI template snippets or generate CLI templates specific to their intent based on these CLI template snippets. In the depicted example, the second node 610b is determined to be a relevant node based on the input query, as shown with a box 620. As such, details of the second node 610b may be rendered to a user via a user interface 700 of FIG. 7.

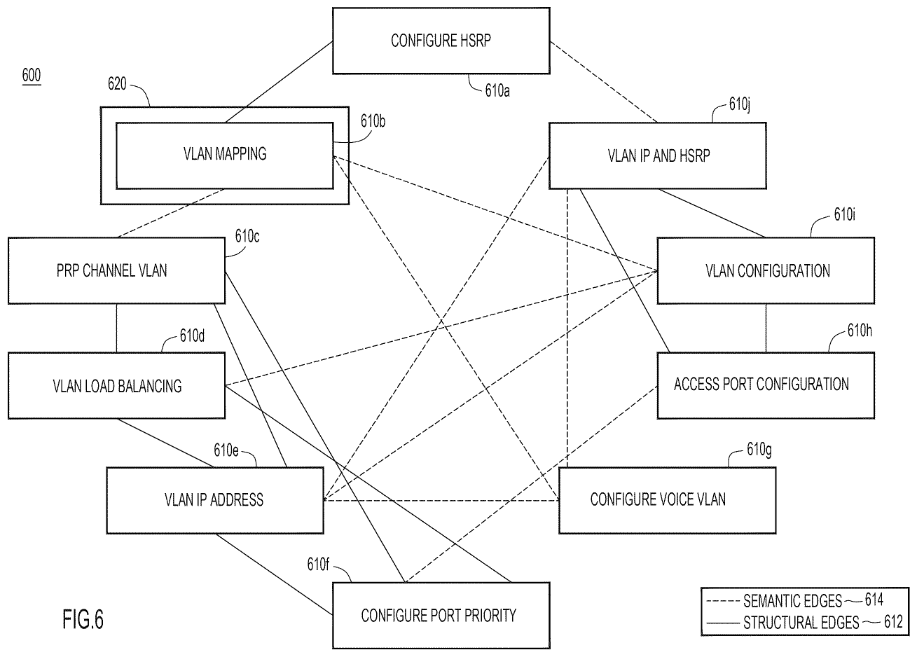

With continued reference to FIGS. 1-6, FIG. 7 illustrates the user interface 700 that provides a generated CLI template snippet with a natural language description for configuring one or more network devices, according to an example embodiment. The generated CLI template snippet includes a name 702, description 704, CLI command set 706, contextual information 708, and source information 710 with source links 712. The generated CLI template snippet is an example of the second node 610b of FIG. 6.

For example, the name 702 includes “VLAN mapping” and the description 704 may be “configures VLAN mapping on a trunk port”. The CLI template snippet is the CLI command set 706 such as:
Interface {{Interface_name}}
Switchport trunk encapsulation dotiq
Switchport mode trunk
Switchport trunk allowed vlan {allowed_vlans}}
Switchport trunk native vlan {{native_vlan}}

The contextual information 708 may include a snippet summary, the name 702, the description 704, templating language (e.g., Jinja), template types (e.g., configure). The source information 710 may identify the source and its type. The source information 710 may further include source links 712 for accessing the respective source and excerpts of the ground truth from the source itself.

The full knowledge graph is deployed to the back end vector database (the template snippets vector database 422b of FIG. 4) with nodes represented as entries and edges stored as part of context-aware metadata. At runtime, as described in FIG. 8, relevant portions of knowledge graphs are retrieved via retrieval augmented generation (RAG) and heavily referenced, with both nodes (content, metadata, filters) and edges considered to assist with auto-generation of the CLI templates in specific templating languages.

With continued reference to FIGS. 1-7, FIG. 8 is a diagram illustrating a method 800 of generating one or more CLI templates in a determined templating language based on an input query, according to an example embodiment. The method 800 may be performed by the multi-language CLI-based template generator 120 of FIG. 1 such as the template editor 440, the CLI template generator 420, and the LLM component 412. The method 800 is performed during runtime. The runtime stage involves a user 802 interacting with the multi-language CLI-based template generator 120 to generate CLI templates 804 in the determined templating language based on CLI template snippets in a related portion of a knowledge graph 806 and by validating the CLI templates 804 using a target network device 808.

Specifically, the method 800 involves at 810, obtaining an input query from the user 802. For example, the user 802 submits a natural language prompt for configuring one or more network devices in a network using a CLI template in specific templating language(s). When the user 802 issues an input query through the template editor UI component 444, at 812, an API request is issued to the templated editor back end component 442. The templated editor back end component 442 determines contextual information about the network including the templating language and generates a template generation API call to the back-end control logic component 424, at 814.

The method 800 further involves at 816, the back-end control logic component 424 of the CLI template generator 420 entering the knowledge graph reference phase and pulling relevant knowledge graph nodes (CLI template snippets in a relevant portion of the knowledge graph 806) from the template snippets vector database 422b of the datastores 421. The back-end control logic component 424 determines relevance via a similarity search using the given user prompt, for example, combining cosine embeddings and Term Frequency-Inverse Document Frequency (TFIDF) search. The aforementioned snippet metadata also enables conditional retrieval (i.e., specific devices, versioning, or licensing).

A relevant portion of templating rules knowledge graph may also be retrieved. That is, the back-end control logic component 424 determines applicable templating rules from the template rule book vector database 422a of the datastores 421 based on contextual information such as a user profile, enterprise information, specific devices, templating language, etc. The back-end control logic component 424 may not only consider the directly retrieved nodes, but also the neighboring nodes as defined by the knowledge graph edges (structural edges 612 and semantic edges 614 in FIG. 6). In this sense, for each user prompt, the back-end control logic component 424 references a localized subset or slice of the full knowledge graph(s). That is, at 818, the back-end control logic component 424 retrieves relevant CLI template snippets and templating rules.

In the knowledge graph reference phase, the back-end control logic component 424 interfaces with the LLM component 412, providing the retrieved knowledge graph and the user prompt. This stage may ask the LLM component 412 to (1) classify the input prompt with a specificity label, and (2) construct a list of relevant, well-worded alternative prompt suggestions.

Then, the back-end control logic component 424 may enter the inference phase, prompting the LLM component 412 to generate a recommended CLI template to address the input query. The LLM component 412 may be provided with a combination of direct user input, dynamically identified editor context, dynamically fetched documentation, and dynamically determined knowledge graph positioning. Documentation chunks are conditionally referenced based on the aforementioned LLM specificity label and the vector database retrieval stage distance metrics. In the inference phase, the method 800 involves at 820, the back-end control logic component 424 prompting the LLM component 412 to generate a variety of output addressing the user prompt. The output includes properly formatted CLI template content in the determined templating language(s), variable details, and recommended follow-up prompts, which may be related or more specific in nature. At 822, the LLM component 412 provides the output to the back-end control logic component 424.

Notably, in one or more example embodiments, the knowledge graph retrieved from the previous phase is included in the LLM context window. The context window also includes dynamically identified aspects of the user's editor environment including surrounding template content, formatting tendencies, system variables, target device types, target versions, etc. In other words, the LLM component 412 is provided with retrieved CLI template snippets, templating rules, and context-aware metadata.

Prior to issuing a response, the back-end control logic component 424 may also validate the generated CLI templates in a post processing phase. The post processing phase may include a rule-based review of template syntax and/or at 824, directly testing the generated CLI template for output effect within a simulated or cloned network environment. For example, the back-end control logic component 424 may use a configuration server to validate the one or more CLI templates on the target network device 808 e.g., an emulated network device. At 826, the back-end control logic component 424 obtains simulation results, which are indicative of whether the target network device 808 is configured according to the input query. The back-end control logic component 424 may then return to operation 820 and prompt the LLM component 412 with the simulated results indicating that the one or more CLI templates are not validated (the target network device 808 is not properly configured). In other words, a feedback loop is provided between the back-end control logic component 424 and the LLM component 412 to ensure that the generated CLI templates are tested and validated.

Existing GenAI assistants rarely have context regarding the end use of the code. In contrast, the CLI template generator 420 has innate knowledge of the eventual use and the generated template may be executed on a certain type of network device. Prior to issuing responses, the back-end control logic component 424 may validate not only the syntax but also the effect of the generated code on the target network device 808.

In one example embodiment, the back-end control logic component 424 generates network device clones emulating the network device type in the network, executes the current configuration template (with the newly suggested CLI template snippet added and reasonable default values set for all variables), issues show commands to assess the outcome (simulation results), autonomously validates the desired effect by analyzing the simulated results indicative of whether the configuration is validated, and re-prompts the LLM component 412 on any failures. As such, the multi-language CLI-based template generator 120 greatly reduce the possibility of experiencing unintended issues and lengthy revisions.

The method 800 further involves at 828, the back-end control logic component 424 providing, to the templated editor back end component 442, the output including the generated CLI templates with their natural language descriptions, respective parameters for one or more network devices in the templating language, and at least one additional input prompt for further enhancements. At 829, the templated editor back end component 442 formats the output, and provides the output to the template editor UI component 444. That is, in the operation 829, the API response is issued to the template editor UI component 444. At 830, the template editor UI component 444 legibly renders the output for user review. The output is rendered in a manner allowing the user 802 to accept, discard, and/or manually edit the CLI templates 804, or iteratively refine via follow-up prompting. Any such subsequent API calls for further enhancements may include some notion of a conversational state.

While in above example embodiments, CLI templates are generated in determined templating languages, the disclosure is not limited thereto. The disclosure may apply to other text-based interface where text based command sets are issued to interact with network devices.

In one or more example embodiments, a multi-language CLI-based template generator may be an interactive content auto-generation system specifically within the context of designing CLI network device templates. As opposed to more traditional methods of editor AI assistance i.e., a chatbot, an autocomplete functionality, the multi-language CLI-based template generator may be more powerful, providing a different level of interactivity and output. These enhancements may be attributed to novel nuances in the underlying system process, examples of which are described above.

While interactive generation systems may exist for general purpose integrated development environments (IDEs), the specific curation of the multi-language CLI-based template generator for use in template editor IDEs addresses unique difficulties. Most notably, typical content generation systems deal with only one core language at a time, whereas the multi-language CLI-based template generator discovers interactions between CLI commands and template wrapper languages.

In one or more example embodiments, the multi-language CLI-based template generator provides pre-anticipation and pre-synthesization of possible CLI prompts by including intent in knowledge graphs. As noted above, inline AI assistance systems use a fill-in-the-middle paradigm to generate suggestions. This approach is intuitive for generic language-agnostic code, as the range of possible input is open-ended. In contrast, the set of CLI questions, especially asked within the context of writing CLI templates, is far more limited. Thus, CLI prompts may be reliably anticipated prior to runtime, tagged with pre-computed context-aware metadata, and statically deployed in a manner that streamlines response times, and rigidly ensures accuracy for common queries. In one or more example embodiments, the CLI prompts may be associated with pre-synthesized entities (CLI template snippets, rules) derived from ground truth resources, tagged with pre-computed filter-enabling metadata, and deployed to vector databases as knowledge graphs. During runtime, the multi-language CLI-based template generator accurately assesses the spatial positioning of any prompt within the realm of possible prompts and extracts a localized knowledge graph in that area (relevant portion of the knowledge graph).

The multi-language CLI-based template generator drives a greater variety of output (i.e., neighboring follow-up prompts, resource links), greater adherence to documented precedents, and greater accuracy for many commonly asked queries. Using of pre-computed knowledge graphs further reduces LLM based hallucinations. In one example embodiment, traditional fill-in-the middle approaches may still be appropriate for template language portions of the response, and the multi-language CLI-based template generator may interweave the two methodologies.

In one or more example embodiments, the multi-language CLI-based template generator pre-synthesizes user input queries (“intents”) based on a wide variety knowledge base such as user guides, tech zone articles, internal experts, etc. and organizes these CLI prompts as knowledge graphs in a vector database. Each node represents a prompt, stores a direct answer in a template form, and maintains edges to related prompts. Existing knowledge frameworks may add edges based on a proxy measure of similarity (i.e., embeddings). In contrast, edges in the vector database generated by the multi-language CLI-based template generator are compiled based on the inherent hierarchy of source documentation, leveraging ground truth data to improve graph accuracy. Nodes may also be tied to specific documentation (links or excerpts) as well as any other relevant metadata such as versioning, licensing, or command classification.

Other knowledge frameworks in similar systems may employ a loosely edge-like notion based on a simple proxy measure of similarity (i.e., embeddings). In contrast, edges of the knowledge graph are also added based on the inherent hierarchy of parent resources, leveraging the intentional structure of documented ground truth reference points to improve knowledge graph accuracy. Many resources have inherent structure, such as PDF guides with hierarchical contents or YANG models with nested formatting. The multi-language CLI-based template generator ensures this knowledge is not lost but instead leveraged to accurately expand the scope of reference during content generation.

In one or more example embodiments, the multi-language CLI-based template generator performs pre-synthesization by generating knowledge graphs based on YANG models. These files (YANG models) have inherent structure and attributes that may be leveraged to enable efficient creation of prompts tagged by data path. Optionally, fill-in-the middle may also be used for template language portions of the response, and the multi-language CLI-based template generator may interweave the two methodologies.

Moreover, in one or more example embodiments, distinct LLM interactions are split into knowledge graph phase and inference phase. The abstract knowledge graphs may be leveraged to tangibly improve output. As opposed to many traditional tools that interface with LLMs, the multi-language CLI-based template generator uses a two-phase LLM interaction that involves the knowledge graph reference phase and the inference phase.

The initial knowledge graph phase is unique and assesses the spatial positioning of the user prompt within the realm of possible prompts, evaluating the relative specificity, and retrieving edges i.e., in this case, prompts that are either related (siblings) or more specific variations (children). These suggested prompts innately guide users from initial vague input queries to more specific language that accurately addresses true user intentions. Moreover, since multi-language CLI-based template generator uses pre-computed knowledge graphs, the LLM based hallucinations may significantly be reduced. The subsequent inference phase generates the CLI template content based on output of the initial knowledge graph phase.

Existing GenAI assistants within IDEs may, by default, reference the content of the current file. However, consideration for other system settings may use manual interventions or specifications. In one or more example embodiments, the multi-language CLI-based template generator is specifically scoped to the task of template generation, the relevant context is less complex to pre-anticipate (similar to pre-anticipation of prompts). The multi-language CLI-based template generator automatically determine device types, firmware versions, and customer licenses without any need for manual entry (without user intervention). For licensing specifically, a role based access control (RBAC)-augmented retrieval process may limit access to reference certain resources. Environment analysis may also include curated integration of application-specific entities, such as recognition of and binding to system variables.

In one or more example embodiments, the multi-language CLI-based template generator may automatically consider wider context of a user's templating environment. Reasoning and output are conditioned to specific device types, firmware versions, and user licenses. This templating metadata or context-aware metadata is dynamically identified without any manual entry or intervention from the user. This automated environment analysis includes integration of application-specific entities, such as recognition and binding of system variables. In one example embodiment, the multi-language CLI-based template generator obtains information about the enterprise network and assets of the enterprise network to generate CLI command specific to the network assets and the templating languages used for configuring these network assets.

Many enterprises have specific template compliance rules. Other existing systems may validate basic formatting, but rarely consider custom compliance unless manually specified at runtime. In one or more example embodiments, the multi-language CLI-based template generator allows users to add compliance stipulations prior to runtime, which is far less tedious or repetitive. The multi-language CLI-based template generator may automate compliance checks for responses (generated CLI templates) reducing manual edits and user involvement. This functionality may also be extended and utilized for full template compliance checks after template design is complete, prior to deployment, processing the template content using the multi-language CLI-based template generator.

In one or more example embodiments, the multi-language CLI-based template generator performs parallel iterative feedback streams curated to address CLI templating scenarios. The output may be iteratively refined by multiple concurrent sources, including automated syntax validation, automated intent validation (possibly using a device clone), manual human edits, and LLM-driven enhancements. This diverse range of available feedback streams balances objective verification with subjective human requests. Automated intent validation is particularly novel, incorporating a device clone as a system node to verify CLI effects prior to template application, catching errors early and minimizing risk of lengthy revisions and redeployment.

The techniques presented herein streamline template design by empowering developers to auto-generate IOS CLI templates in various templating languages in response to natural language prompts. CLI template content generation is AI powered, includes embedded documentation, pre-synthesized knowledge graphs, and automatic consideration of users'specific templating environment context. In contrast to traditional chat based interfaces, the multi-language CLI-based template generator may be more powerful and interactive, allowing users to iteratively issue manual edits and/or request LLM-driven enhancements. The techniques presented herein leverage the unique notion of pre-anticipated prompts and pre-synthesized knowledge graphs to generate more diverse and informative output.

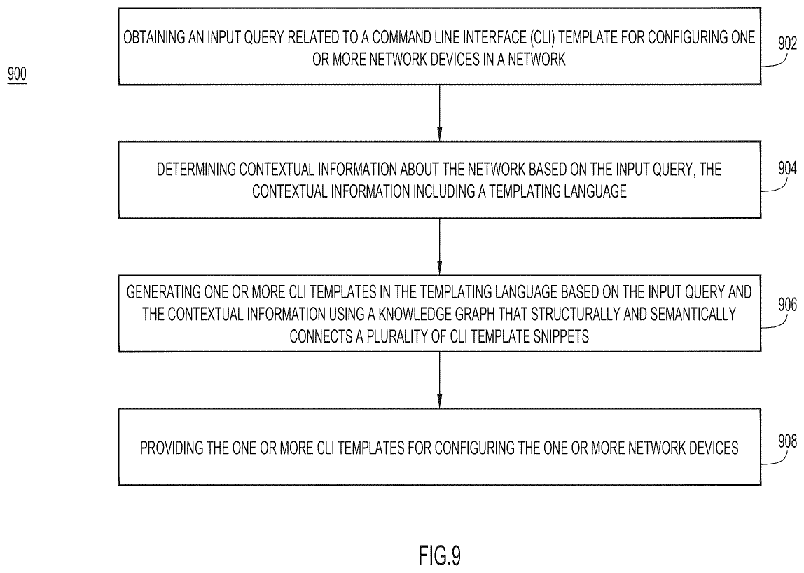

FIG. 9 is a flowchart illustrating a method 900 in which CLI-based language specific templates are generated based on input queries and provided for configuring network devices in a network, according to an example embodiment. The method 900 may be performed by the multi-language CLI-based template generator 120, executed by a computing device of FIG. 10 and/or one or more servers that implement the system described above with reference to FIGS. 1-8, and/or in a cloud.

The method 900 involves at 902, obtaining an input query related to a command line interface (CLI) template for configuring one or more network devices in a network.

The method 900 further involves at 904, determining contextual information about the network based on the input query. The contextual information includes a templating language.

The method 900 further involves at 906, generating one or more CLI templates in the templating language based on the input query and the contextual information using a knowledge graph that structurally and semantically connects a plurality of CLI template snippets.

The method 900 further involves at 908, providing the one or more CLI templates for configuring the one or more network devices.

In one form, the method 900 may further involve configuring the one or more network devices based on the one or more CLI templates to generate a result and validating the one or more CLI templates on the one or more network devices in the network based on the result.

In one instance, the method 900 may further involve generating one or more new CLI templates in the templating language based on the one or more CLI templates not being validated.

According to one or more example embodiments, the method 900 may further involve executing the one or more CLI templates on a target network device in a simulated network and generating a simulation result indicative of whether the target network device is configured according to the input query. The method 900 may further involve validating the one or more CLI templates based on the simulation result.

In another form, the method 900 may further involve generating one or more new CLI templates in the templating language based on the one or more CLI templates not being validated. The operation of generating the one or more new CLI templates may involve obtaining a set of CLI template snippets from a knowledge graph based on the input query and prompting an artificial intelligence (AI) model with the set of CLI template snippets, the input query, the contextual information including the templating language, and the simulation result for the one or more CLI templates.

In one instance, the operation 908 of providing the one or more CLI templates for configuring the one or more network devices may involve providing a set of CLI commands with respective parameters of the one or more network devices in the templating language along with a natural language description and at least one additional input prompt for obtaining one or more related sets of CLI commands.

In another instance, the method 900 may further involve generating the knowledge graph by extracting the plurality of CLI template snippets from one or more sources, and tagging each of the plurality of CLI template snippets with context-aware metadata and intent. The context-aware metadata may include one or more network device types, one or more parameters, and acceptable values for the one or more parameters for CLI commands in a respective CLI template snippet. The intent may include a plurality of natural language prompts related to the respective CLI template snippet.

According to one or more example embodiments, the operation of generating the knowledge graph may further involve generating at least one structural edge that connects the context-aware metadata of the respective CLI template snippet with at least one first CLI template snippet based on a source and generating at least one semantic edge that connects the context-aware metadata of the respective CLI template snippet with at least one second CLI template snippet that is semantically similar to the respective CLI template snippet.

In one form, the operation 906 of generating the one or more CLI templates in the templating language may further be based on an additional knowledge graph that includes a plurality of structurally and semantically connected templating rules.

In another form, the operation 906 of generating the one or more CLI templates in the templating language may involve obtaining a set of CLI template snippets from the knowledge graph based on the input query and prompting an artificial intelligence (AI) model with the set of CLI template snippets, the input query, and the contextual information including the templating language, to generate the one or more CLI templates.

FIG. 10 is a hardware block diagram of a computing device 1000 that may perform functions associated with any combination of operations in connection with the techniques depicted in FIGS. 1-9, according to various example embodiments, including, but not limited to, operations of a console that may be executing a user interface or another network management system, one or more servers executing various AI models of FIGS. 1-9, and/or a network device such as an asset of an enterprise network. It should be appreciated that FIG. 9 provides only an illustration of one example embodiment and does not imply any limitations with regard to the environments in which different embodiments may be implemented. Many modifications to the depicted environment may be made.

In at least one embodiment, computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with one or more memory elements 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, and/or any other I/O port(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 1016, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to communicate in a network, and a processor coupled to the network interface. The processor is configured to perform operations that include obtaining an input query related to a command line interface (CLI) template for configuring one or more network devices in a network and determining contextual information about the network based on the input query. The contextual information includes a templating language. The operations further include generating one or more CLI templates in the templating language based on the input query and the contextual information using a knowledge graph that structurally and semantically connects a plurality of CLI template snippets and providing the one or more CLI templates for configuring the one or more network devices.

In yet another example embodiment, one or more non-transitory computer readable storage media encoded with instructions are provided. When the media is executed by a processor, the instructions cause the processor to execute a method that includes obtaining an input query related to a command line interface (CLI) template for configuring one or more network devices in a network and determining contextual information about the network based on the input query. The contextual information includes a templating language. The method further includes generating one or more CLI templates in the templating language based on the input query and the contextual information using a knowledge graph that structurally and semantically connects a plurality of CLI template snippets and providing the one or more CLI templates for configuring the one or more network devices.

In yet another example embodiment, a system is provided that includes the devices and operations explained above with reference to FIGS. 1-10.

The programs described herein (e.g., control logic 1020) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1006 and/or memory elements(s) 1004 can store data, software, code, instructions (e.g., processor instructions), logic, parameters, combinations thereof, and/or the like used for operations described herein. This includes the storage 1006 and/or memory elements(s) 1004 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein, may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining an input query related to a command line interface (CLI) template for configuring one or more network devices in a network;
determining contextual information about the network based on the input query, the contextual information including a templating language;
generating one or more CLI templates in the templating language based on the input query and the contextual information using a knowledge graph that structurally and semantically connects a plurality of CLI template snippets; and
providing the one or more CLI templates for configuring the one or more network devices.

2. The method of claim 1, further comprising:
configuring the one or more network devices based on the one or more CLI templates to generate a result; and
validating the one or more CLI templates on the one or more network devices in the network based on the result.

3. The method of claim 2, further comprising:
generating one or more new CLI templates in the templating language based on the one or more CLI templates not being validated.

4. The method of claim 1, further comprising:
executing the one or more CLI templates on a target network device in a simulated network;
generating a simulation result indicative of whether the target network device is configured according to the input query; and
validating the one or more CLI templates based on the simulation result.

5. The method of claim 4, further comprising:
generating one or more new CLI templates in the templating language based on the one or more CLI templates not being validated, wherein generating the one or more new CLI templates includes:
obtaining a set of CLI template snippets from a knowledge graph based on the input query; and
prompting an artificial intelligence (AI) model with the set of CLI template snippets, the input query, the contextual information including the templating language, and the simulation result for the one or more CLI templates.

6. The method of claim 1, wherein providing the one or more CLI templates for configuring the one or more network devices includes:
providing a set of CLI commands with respective parameters of the one or more network devices in the templating language along with a natural language description and at least one additional input prompt for obtaining one or more related sets of CLI commands.

7. The method of claim 1, further comprising:
generating the knowledge graph by:
extracting the plurality of CLI template snippets from one or more sources, and
tagging each of the plurality of CLI template snippets with context-aware metadata and intent, wherein the context-aware metadata includes one or more network device types, one or more parameters, and acceptable values for the one or more parameters for CLI commands in a respective CLI template snippet, and wherein the intent includes a plurality of natural language prompts related to the respective CLI template snippet.

8. The method of claim 7, wherein generating the knowledge graph further includes:
generating at least one structural edge that connects the context-aware metadata of the respective CLI template snippet with at least one first CLI template snippet based on a source; and
generating at least one semantic edge that connects the context-aware metadata of the respective CLI template snippet with at least one second CLI template snippet that is semantically similar to the respective CLI template snippet.

9. The method of claim 1, wherein generating the one or more CLI templates in the templating language is further based on an additional knowledge graph that includes a plurality of structurally and semantically connected templating rules.

10. The method of claim 1, wherein generating the one or more CLI templates includes:
obtaining a set of CLI template snippets from the knowledge graph based on the input query; and
prompting an artificial intelligence (AI) model with the set of CLI template snippets, the input query, and the contextual information including the templating language, to generate the one or more CLI templates.

11. An apparatus comprising:
a network interface to communicate in a network; and
a processor coupled to the network interface and configured to perform operations comprising:
obtaining an input query related to a command line interface (CLI) template for configuring one or more network devices in a network;
determining contextual information about the network based on the input query, the contextual information including a templating language;
generating one or more CLI templates in the templating language based on the input query and the contextual information using a knowledge graph that structurally and semantically connects a plurality of CLI template snippets; and
providing the one or more CLI templates for configuring the one or more network devices.

12. The apparatus of claim 11, wherein the processor is further configured to perform:
configuring the one or more network devices based on the one or more CLI templates to generate a result; and
validating the one or more CLI templates on the one or more network devices in the network based on the result.

13. The apparatus of claim 12, wherein the processor is further configured to perform:
generating one or more new CLI templates in the templating language based on the one or more CLI templates not being validated.

14. The apparatus of claim 11, wherein the processor is further configured to perform:
executing the one or more CLI templates on a target network device in a simulated network;
generating a simulation result indicative of whether the target network device is configured according to the input query; and
validating the one or more CLI templates based on the simulation result.

15. The apparatus of claim 14, wherein the processor is further configured to perform:
generating one or more new CLI templates in the templating language based on the one or more CLI templates not being validated,
wherein the processor generates the one or more new CLI templates by:
obtaining a set of CLI template snippets from a knowledge graph based on the input query, and
prompting an artificial intelligence (AI) model with the set of CLI template snippets, the input query, the contextual information including the templating language, and the simulation result for the one or more CLI templates.

16. The apparatus of claim 11, wherein the processor is configured to provide the one or more CLI templates for configuring the one or more network devices by:
providing a set of CLI commands with respective parameters of the one or more network devices in the templating language along with a natural language description and at least one additional input prompt for obtaining one or more related sets of CLI commands.

17. One or more non-transitory computer readable storage media encoded with instructions that, when executed by a processor, cause the processor to execute a method comprising:
obtaining an input query related to a command line interface (CLI) template for configuring one or more network devices in a network;
determining contextual information about the network based on the input query, the contextual information including a templating language;
generating one or more CLI templates in the templating language based on the input query and the contextual information using a knowledge graph that structurally and semantically connects a plurality of CLI template snippets; and
providing the one or more CLI templates for configuring the one or more network devices.

18. The one or more non-transitory computer readable storage media of claim 17, wherein the method further comprises:
configuring the one or more network devices based on the one or more CLI templates to generate a result; and
validating the one or more CLI templates on the one or more network devices in the network based on the result.

19. The one or more non-transitory computer readable storage media of claim 18, wherein the method further comprises:
generating one or more new CLI templates in the templating language based on the one or more CLI templates not being validated.

20. The one or more non-transitory computer readable storage media of claim 17, wherein the method further comprises:
executing the one or more CLI templates on a target network device in a simulated network;
generating a simulation result indicative of whether the target network device is configured according to the input query; and
validating the one or more CLI templates based on the simulation result.
